(19) United States
(12) Patent Application Publication
(10) Pub. No.: US 2025/0052920 A1
(43) Pub. Date: Feb. 13, 2025

(54) JOINT LANDSLIDE MONITORING SYSTEM AND METHOD

(71) Applicant: China Academy of Safety Science and Technology, Beijing (CN)

(72) Inventors: Haitao MA, Beijing (CN); Hongnan QIN, Beijing (CN); Zhengxing YU, Beijing (CN); Xiteng LI, Beijing (CN)

(21) Appl. No.: 18/484,576

(22) Filed: Oct. 11, 2023

(30) Foreign Application Priority Data
Aug. 11, 2023 (CN) 2023110150822

(51) Int. Cl. G01V 1/28; G01V 1/30; G01V 3/12; G01V 11/00

(52) U.S. Cl. CPC G01V 1/288; G01V 1/307; G01V 3/12; G01V 11/00

(57) ABSTRACT

Disclosed are a joint landslide monitoring system and method. The system includes: a high-frequency electromagnetic wave monitoring module configured to continuously emit electromagnetic wave signals into a monitoring area, perform interference processing on signals received by a receiving antenna to obtain target signals, and obtain surface deformation information of the monitoring area according to a phase difference of the target signals; a low-frequency seismic wave monitoring module configured to propagate seismic waves downward from a ground surface in the monitoring area, receive reflected waves from a creeping medium that the seismic waves encounter, obtain frequency-domain interference characteristics of internal creeping; and determine a longitudinal force on a 3D stratigraphic landslide mass shear surface; and a cloud platform configured to determine a maximum subsidence amount and a subsidence velocity of the monitoring area, and issue alert information when the maximum subsidence amount or the subsidence velocity exceeds a preset range.

### CROSS REFERENCE TO RELATED APPLICATION

This patent application claims priority of Chinese Patent Application No. 2023110150822, filed with the China National Intellectual Property Administration on Aug. 11, 2023, the disclosure of which is incorporated by reference herein in its entirety as part of the present application.

### TECHNICAL FIELD

The present disclosure relates to the technical field of geological hazard monitoring, and in particular, to a joint landslide monitoring system and method.

### BACKGROUND

Landslides are one of the most common geological disasters in mountainous areas. In recent years, landslides have occurred frequently, resulting in casualties and property losses. Therefore, to ensure the safety of people's lives, it is essential to monitor and warn about landslides.

Currently, the main methods for monitoring landslides include video monitoring, Global Positioning System (GPS) monitoring, laser radar monitoring, and seismic wave monitoring. Among these methods, video monitoring provides visual images that can show the size and shape of foreign objects, and has a medium detection range, but it is greatly influenced by lighting and weather conditions. GPS monitoring requires sensors to be buried around monitoring points, which is a single-point monitoring technique and can only observe deformations at the monitoring points and in the vicinity thereof, failing to fully capture the overall deformation of slopes. Laser radar can generate 3D point cloud images and display factors such as the size and shape of foreign objects but can only measure 2D deformations. It is also affected by vegetation, vehicles, lighting, and weather conditions, which limits its effectiveness. Seismic wave monitoring can capture underground structures, but it has a low signal-to-noise ratio, long wavelength of excitation, and insufficient high-frequency signals, which result in inadequate resolution for ultra-shallow monitoring and early warning requirements. Landslide monitoring relying solely on shallow or deep detection makes it challenging to achieve precise prediction and accurate early warning of landslide disasters.

### SUMMARY

An objective of the present disclosure is to provide a joint landslide monitoring system and method, which improve the accuracy of landslide monitoring.

To achieve the above objective, the present disclosure provides the following technical solutions.

A joint landslide monitoring system is provided, including:
a high-frequency electromagnetic wave monitoring module configured to continuously emit electromagnetic wave signals into a monitoring area through a transmitting antenna, and scan space of the monitoring area with emitted waves by changing a phase distribution on an aperture of the transmitting antenna; amplify signals received by a receiving antenna and perform interference processing on the amplified signals to obtain target signals; and obtain surface deformation information of the monitoring area according to a phase difference of the target signals, where the surface deformation information includes a position of a landslide mass and landslide velocity information;
a low-frequency seismic wave monitoring module configured to propagate seismic waves downward from a ground surface in the monitoring area and receive reflected waves from a creeping medium that the seismic waves encounter, where the reflected waves continue to propagate downward after reaching the ground surface; obtain frequency-domain interference characteristics of internal creeping in the monitoring area according to the reflected waves received in multiple times; and determine, according to the frequency-domain interference characteristics, a longitudinal force on a 3D stratigraphic landslide mass shear surface in the monitoring area; and

a cloud platform configured to collect the surface deformation information sent by the high-frequency electromagnetic wave monitoring module and the longitudinal force on the 3D stratigraphic landslide mass shear surface sent by the low-frequency seismic wave monitoring module; determine a maximum subsidence amount and a subsidence velocity of the monitoring area according to the surface deformation information and the longitudinal force on the 3D stratigraphic landslide mass shear surface collected within a same period of time; and issue alert information when the maximum subsidence amount exceeds a subsidence amount threshold or the subsidence velocity exceeds a subsidence velocity threshold.

Optionally, the high-frequency electromagnetic wave monitoring module includes:
a synthesizer configured to generate frequency-modulated signals;
the transmitting antenna configured to continuously emit the frequency-modulated signals into the monitoring area, where the frequency-modulated signals are electromagnetic wave signals;
the receiving antenna configured to receive mixed-frequency signals, which are a mixture of the frequency-modulated signals and delayed frequency-modulated signals reflected back;
a filter connected to the receiving antenna and configured to filter out intermediate frequency signals within a preset frequency range;
a first analog-to-digital converter connected to the filter and configured to convert the intermediate frequency signals into digital signals, referred to as first digital signals;
a digital signal processor (DSP) connected to the first analog-to-digital converter and configured to perform a fast Fourier transform (FFT) on the digital signals; and
a constant false alarm rate (CFAR) detection module connected to the DSP and configured to perform CFAR detection on the digital signals after the FFT, to obtain high-frequency electromagnetic wave data.

Optionally, the low-frequency seismic wave monitoring module includes:
a detector configured to propagate seismic waves downward from the ground surface in the monitoring area, collect mechanical signals representing linear vibrations of the ground surface in the monitoring area, and convert the mechanical signals into electrical signals;
a period extender connected to the detector and configured to extend a frequency bandwidth of the detector to obtain bandwidth-extended signals; and
a second analog-to-digital converter, which is a multi-channel analog-to-digital converter, connected to the period extender and configured to convert the bandwidth-extended signals into digital signals, referred to as second digital signals, according to requirements of each channel.

Optionally, the detector includes a three-axis vibration sensor configured to detect mechanical signals of linear vibrations in three Cartesian axis directions.

Optionally, the subsidence velocity threshold is 5 mm/h.

Optionally, the system further includes a first 5G data transmission module and a second 5G data transmission module; the high-frequency electromagnetic wave monitoring module and the cloud platform are connected through the first 5G data transmission module; and the low-frequency seismic wave monitoring module and the cloud platform are connected through the second 5G data transmission module.

The present disclosure further provides a joint landslide monitoring method, including the following steps:
continuously emitting, by a high-frequency electromagnetic wave monitoring module, electromagnetic wave signals into a monitoring area through a transmitting antenna, and scanning space of the monitoring area with emitted waves by changing a phase distribution on an aperture of the transmitting antenna; amplifying signals received by a receiving antenna and performing interference processing on the amplified signals to obtain target signals; and obtaining surface deformation information of the monitoring area according to a phase difference of the target signals, where the surface deformation information includes a position of a landslide mass and landslide velocity information;
propagating, by a low-frequency seismic wave monitoring module, seismic waves downward from a ground surface in the monitoring area, and receiving reflected waves from a creeping medium that the seismic waves encounter, where the reflected waves continue to propagate downward after reaching the ground surface; obtaining frequency-domain interference characteristics of internal creeping in the monitoring area according to the reflected waves received in multiple times; and determining, according to the frequency-domain interference characteristics, a longitudinal force on a 3D stratigraphic landslide mass shear surface in the monitoring area; and
collecting, by a cloud platform, the surface deformation information sent by the high-frequency electromagnetic wave monitoring module and the longitudinal force on the 3D stratigraphic landslide mass shear surface sent by the low-frequency seismic wave monitoring module; determining a maximum subsidence amount and a subsidence velocity of the monitoring area according to the surface deformation information and the longitudinal force on the 3D stratigraphic landslide mass shear surface collected within a same period of time; and issuing alert information when the maximum subsidence amount exceeds a subsidence amount threshold or the subsidence velocity exceeds a subsidence velocity threshold.

According to specific embodiments provided in the present disclosure, the present disclosure has the following technical effects:
In the present disclosure, the high-frequency electromagnetic wave monitoring module obtains the surface deformation information of the monitoring area, and the low-frequency seismic wave monitoring module obtains the longitudinal force on the 3D stratigraphic landslide mass shear surface of the monitoring area. The maximum subsidence amount and the subsidence velocity of the monitoring area are determined according to the surface deformation information and the longitudinal force on the 3D stratigraphic landslide mass shear surface collected within the same period of time. When the maximum subsidence amount exceeds the subsidence amount threshold or the subsidence velocity exceeds the subsidence velocity threshold, alert information is issued.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a schematic structural diagram of a joint landslide monitoring system according to an embodiment of the present disclosure;

FIG. 2 is a schematic flowchart of a joint landslide monitoring system according to an embodiment of the present disclosure;

FIG. 3 is a principle diagram of monitoring implemented based on electromagnetic waves reflected by a slope radar according to an embodiment of the present disclosure;

FIG. 4 is a principle block diagram of a joint landslide monitoring system according to an embodiment of the present disclosure;

FIG. 5 is a block diagram of a working principle of a high-frequency electromagnetic wave monitoring module according to an embodiment of the present disclosure; and

FIG. 6 is a block diagram of a working principle of a low-frequency seismic wave monitoring module according to an embodiment of the present disclosure.

### DESCRIPTION OF REFERENCE NUMERALS

1—slope radar, 2—upper gravel and fill layer, 3—upper mudstone, 4—lower mudstone, 5—upper sandstone, 6—bedrock.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a joint landslide monitoring system and method, which improve the accuracy of landslide monitoring.

In order to make the above objective, features and advantages of the present disclosure clearer and more comprehensible, the present disclosure will be further described in detail below in combination with accompanying drawings and particular implementation modes.

### Embodiment 1

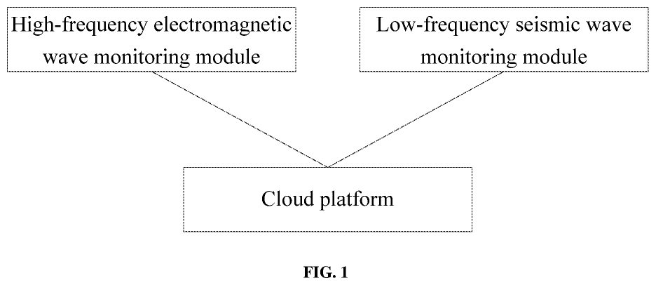

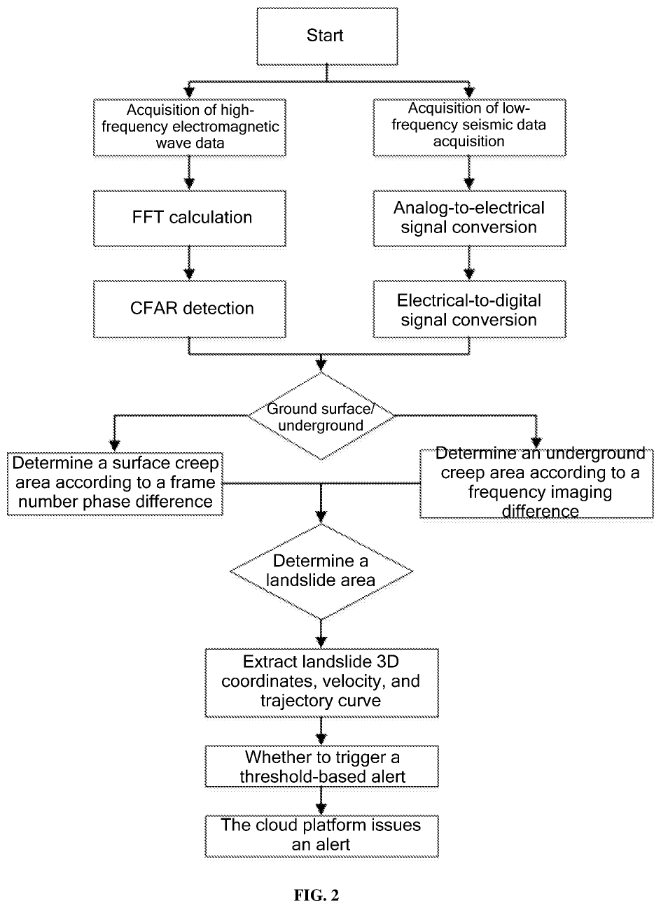

As shown in FIG. 1 and FIG. 2, this embodiment of the present provides a joint landslide monitoring system, including a high-frequency electromagnetic wave monitoring module, a low-frequency seismic wave monitoring module, and a cloud platform.

The high-frequency electromagnetic wave monitoring module is configured to continuously emit electromagnetic wave signals into a monitoring area through a transmitting antenna, and scan space of the monitoring area with emitted waves by changing a phase distribution on an aperture of the transmitting antenna; amplify signals received by a receiving antenna and perform interference processing on the amplified signals to obtain target signals; and obtain surface deformation information of the monitoring area according to a phase difference of the target signals, where the surface deformation information includes a position of a landslide mass and landslide velocity information.

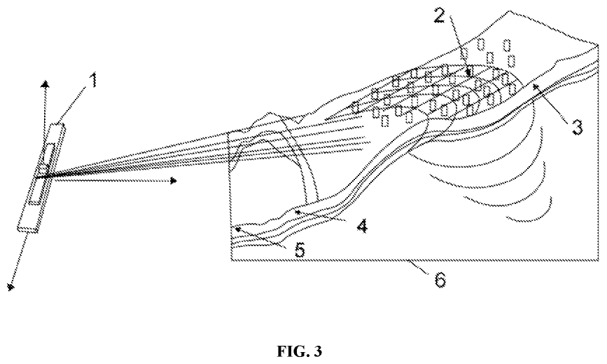

Based on the continuously obtained target signals, surface deformation information in the monitoring area within a continuous period of time are obtained. As shown in FIG. 3, a slope radar 1 emits electromagnetic wave signals into the monitoring area. An upper gravel and fill layer 2, upper mudstone 3, lower mudstone 4, and upper sandstone 5 on bedrock 6 in the monitoring area all receive the electromagnetic wave signals. Based on the signals received by the receiving antenna, surface deformation information on the bedrock 6 is obtained.

Specifically, the high-frequency electromagnetic wave monitoring module emits electromagnetic wave signals to a monitoring target (area). First, radiation units on a radar antenna are arranged in sequence, and different frequency bands are set automatically according to factors such as the size and distance of the monitoring target (area). Secondly, by changing the phase distribution on the aperture of the antenna, array reconfiguration is achieved, and the scanning of the emitted beam in space is completed. The amplifier embedded in each antenna unit amplifies the information to a corresponding level. In combination with the Doppler Beam Sharpening (DBS) technology, beam adaptive control is implemented. Interference processing is performed on the received signals, to obtain a phase difference of the target signals, and form a beam with a different phase, thereby accurately obtaining the position and velocity information of the landslide mass.

The low-frequency seismic wave monitoring module is configured to propagate seismic waves downward from a ground surface in the monitoring area, and receive reflected waves from a creeping medium that the seismic waves encounter, where the reflected waves continue to propagate downward after reaching the ground surface; obtain frequency-domain interference characteristics of internal creeping in the monitoring area according to the reflected waves received in multiple times; and determine, according to the frequency-domain interference characteristics, a longitudinal force on a 3D stratigraphic landslide mass shear surface shear surface in the monitoring area based on a natural source three-component earthquake frequency imaging technology.

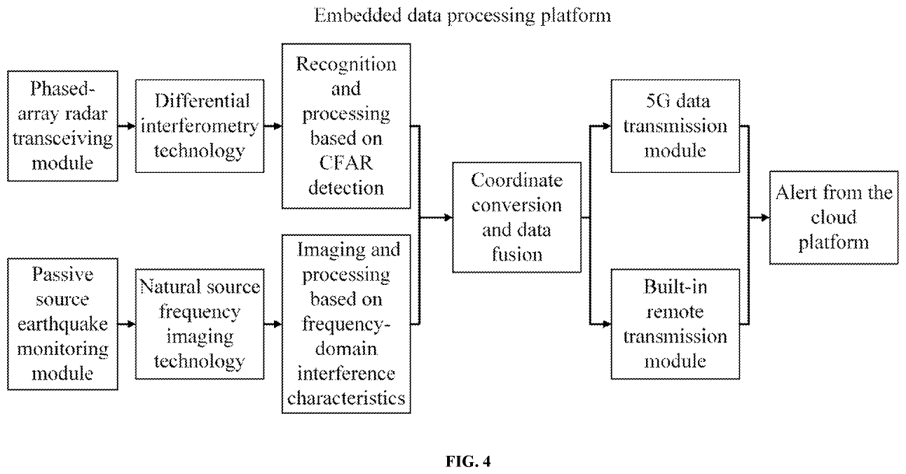

The cloud platform is configured to collect the surface deformation information sent by the high-frequency electromagnetic wave monitoring module and the longitudinal force on the 3D stratigraphic landslide mass shear surface sent by the low-frequency seismic wave monitoring module; determine a maximum subsidence amount and a subsidence velocity of the monitoring area according to the surface deformation information and the longitudinal force on the 3D stratigraphic landslide mass shear surface collected within a same period of time; and issue alert information when the maximum subsidence amount exceeds a subsidence amount threshold or the subsidence velocity exceeds a subsidence velocity threshold. A working principle of the joint landslide monitoring system according to the present disclosure is shown in FIG. 4.

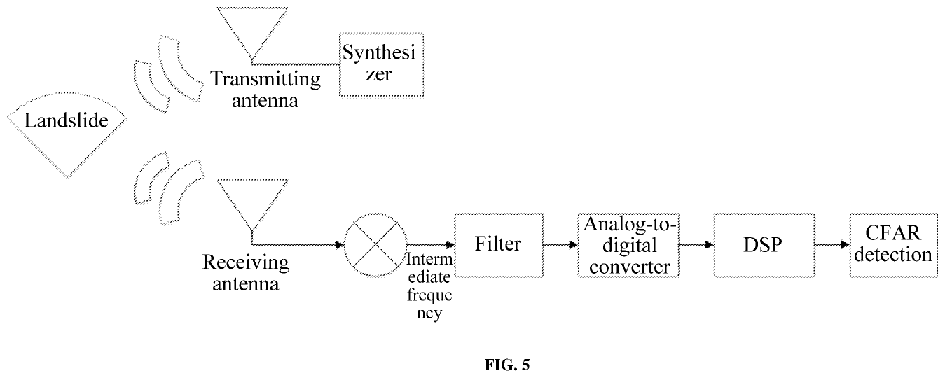

As shown in FIG. 5, the high-frequency electromagnetic wave monitoring module includes: a synthesizer, a transmitting antenna, a receiving antenna, a filter, a first analog-to-digital converter, a DSP, a CFAR detection module, and a clock.

The synthesizer is configured to generate frequency-modulated signals.

The transmitting antenna is configured to continuously emit the frequency-modulated signals into the monitoring area. The frequency-modulated signals are electromagnetic wave signals.

The receiving antenna is configured to receive mixed-frequency signals, which are a mixture of the frequency-modulated signals and delayed frequency-modulated signals reflected back.

The filter is connected to the receiving antenna and configured to filter out intermediate frequency signals within a preset frequency range.

The first analog-to-digital converter is connected to the filter and configured to convert the intermediate frequency signals into digital signals, referred to as first digital signals.

The DSP is connected to the first analog-to-digital converter and configured to perform a FFT on the digital signals.

The CFAR detection module is connected to the DSP and configured to perform CFAR detection on the digital signals after the FFT, and perform noise processing on target (area) deformation information. In the monitoring for landslide mass deformations, the clutter environment is complex. Therefore, in the present disclosure, a non-parametric detector is selected to handle potential strong interference. Detection units of regional cells are subjected to feature analysis, and clutter parameters of the detection units are estimated and normalized.

The transmitting antenna and receiving antenna are emission components. In the high-frequency electromagnetic wave monitoring module, the radar operates in a frequency-modulated continuous wave (FMCW) mode, allowing for continuous transmission of frequency-modulated signals to the monitoring area.

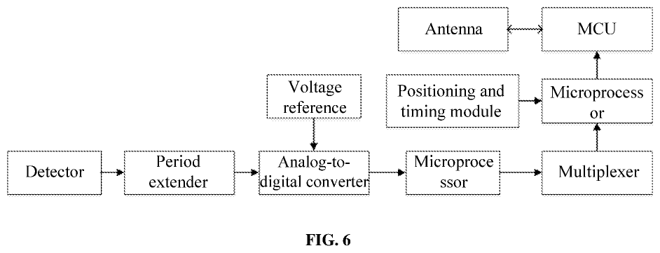

As shown in FIG. 6, the low-frequency seismic wave monitoring module includes a detector, a period extender, a second analog-to-digital converter, a positioning and timing module, a microcontroller unit (MCU), a microprocessor (such as DSP), a multiplexer, and an antenna. It can achieve mutual conversion among analog, electrical, and digital signals, enabling natural source frequency imaging.

The detector is configured to propagate seismic waves downward from the ground surface in the monitoring area, collect mechanical signals representing linear vibrations of the ground surface in the monitoring area, and convert the mechanical signals into electrical signals.

The period extender is connected to the detector and configured to extend a frequency bandwidth of the detector to obtain bandwidth-extended signals.

The second analog-to-digital converter, which is a multi-channel analog-to-digital converter, is connected to the period extender and configured to convert the bandwidth-extended signals into digital signals, referred to as second digital signals, according to requirements of each channel.

The positioning and timing module is configured to continuously digitize signals and synchronously acquires digitized signals based on preset parameters on a fixed measurement position, and store the acquired digitized signals in a solid-state memory.

The detector includes a three-axis vibration sensor configured to detect mechanical signals of linear vibrations in three Cartesian axis directions. The three Cartesian axis directions are eastward, northward, and upward.

The subsidence velocity threshold is 5 mm/h.

The cloud platform receives real-time information such as landslide position, velocity, and trajectory from the high-frequency electromagnetic wave monitoring module and the low-frequency seismic wave monitoring module and stores the information. Additionally, the cloud platform has a remote configuration function, allowing remote configuration of device parameters and system firmware upgrades.

The joint landslide monitoring system of the present disclosure further includes a first 5G data transmission module and a second 5G data transmission module. The high-frequency electromagnetic wave monitoring module and the cloud platform are connected through the first 5G data transmission module. The low-frequency seismic wave monitoring module and the cloud platform are connected through the second 5G data transmission module. The first 5G data transmission module and the second 5G data transmission module are each composed of a 5G network module and a battery module. The 5G network module includes a baseband chip, an RF module, and a Peripheral Component Interconnect Express (PCI-E) interface. The 5G network module is compatible with Internet of Things (IoT) cards from the three major operators, supports various communication protocols such as Transmission Control Protocol (TCP), User Datagram Protocol (UDP), Hypertext Transfer Protocol (HTTP), and WebSocket, and is connected to the detector via cables to provide a remote transmission function.

The specific workflow of the joint landslide monitoring system of the present disclosure is as follows:

Step 1: Obtain surface deformation information of a mountain (monitoring area).

Based on the ground-based differential synthetic aperture radar interferometry technology and by using the high-frequency KU radio band, an RF transmitting module and an antenna emit electromagnetic waves to the monitoring area. With such a high frequency, millimeter waves can be reflected. High resolution is achieved in the range direction through pulse compression and in the azimuth direction through beam sharpening, thereby obtaining a 2D high-resolution image of the monitoring area. A radar transmitting module sends electromagnetic waves to the monitoring area, and a radar receiving module receives electromagnetic waves reflected back from a target. An embedded data processing platform collects raw echo data of the radar through a high-speed AD acquisition module. By performing FFT calculation and CFAR detection on the echo data, information about a potential landslide mass is obtained. A series of 2D high-resolution images obtained from the same target area at different times are combined using the differential interferometry technology, and a phase difference of each pixel in the image is inverted to obtain millimeter-level-accuracy deformation information of the measured area. Velocity information of the potential landslide mass is calculated based on the Doppler principle, and angle information of the landslide mass is calculated using differences in distances between potential landslide mass and multiple antennas. Specific working steps were as follows:

In the first step, the synthesizer generates chirp signals (linear frequency-modulated signals).

In the second step, the chirp signals are transmitted to the monitoring area through the transmitting antenna, and the receiving antenna receives delayed chirp signals that are reflected back.

In the third step, after the received signals are mixed with the transmitted signals, multiple intermediate frequency signals are obtained. Desired intermediate frequency signals are filtered out by a filter. A distance of the landslide mass can be calculated using the intermediate frequency signals.

In the fourth step, the intermediate frequency signals are sampled and converted into digital signals by the analog-to-digital converter.

In the fifth step, after FFT processing and CFAR detection are performed on the digital signals, different spectral positions represent landslide positions at different distances.

In the sixth step, the peripheral first 5G data transmission module collects the data and transmits the data to the cloud platform.

Step 2: Obtain longitudinal shear force information of the interior of the mountain.

Based on the natural source three-component seismic frequency imaging technology, shallow high-resolution exploration is achieved by utilizing noise signals. Underground reflection coefficients are employed, where some strata interfaces have positive reflection coefficients, which are superimposed in the same phase, contribute to reinforced interference in the frequency domain. This is used to extract interference characteristics of seismic wave signals in the frequency domain. The frequency axis corresponds to depth, and the amplitude corresponds to geological body reflection. Through analog-to-electrical signal conversion and electrical-to-digital signal conversion, the investigation and 3D modeling of a slip surface structure in the stratum are achieved. Critical layers in the landslide mass that are prone to deformation are analyzed, and changes in density of the critical layers due to factors such as vibrations and rainwater infiltration are closely monitored. By monitoring abnormal amplitudes in frequency imaging reflected by the changes in the density of the critical layers, monitoring of the landslide mass is achieved. Specific working steps of the low-frequency seismic wave monitoring module are as follows:

In the first step, the detector captures linear vibration components of the mountain landslide in three Cartesian axes. The three-axis vibration sensors are orthogonally placed, oriented eastwards, northwards, and upwards. Detection is performed based on the frequency-domain interference characteristics of seismic waves. Seismic waves are excited on the surface of the mountain and propagate downward. When the seismic waves encounter a creeping medium, reflected waves are generated. After reaching the surface, the reflected waves continue to propagate downward, and reflect back to the surface of the mountain again after encountering defect. The detector detects the linear vibration components of the mountain landslide based on the principle of impedance differences between the creeping medium and the surrounding medium at the location of the creeping medium, and analyzes results of multiple reflections to obtain the frequency-domain characteristics of the internal creeping of the mountain. At this point, the low-frequency seismic wave monitoring module converts mechanical signals of vibrations into electrical signals.

In the second step, the converted voltage is inputted through cables to the period extender, which is used to extend the frequency bandwidth of the detector to amplify the frequencies. Simultaneously, a gain amplifier is used to adjust the bias of an input signal (an output signal of the period extender) to the center of the detection range of the analog-to-digital converter.

In the third step, an embedded analog and digital signal conditioning module of the multi-channel analog-to-digital converter allows individual configuration of each analog input channel in use through a serial peripheral interface (SPI). Integrated true rail-to-rail buffers at an analog input terminal and a reference voltage input terminal provide easy-to-drive high-impedance inputs. In specific execution, switching between different digital filters can be performed according to the requirements of each channel. Further digital processing functions are further provided, such as offset and gain calibration registers, which can be configured based on channels to perform offset and amplification processing on voltage signals outputted from the detector unit, to convert the voltage signals into digital signals (the second digital signals). General input/output can control external multiplexers and synchronize with the conversion timing of the multi-channel analog-to-digital converter.

In the fourth step, the positioning and timing module, along with a high-sensitivity active antenna, supports on-site equipment self-check, wireless status inquiry, and real-time retrieval and feedback of collected data. Based on a programmable micro DSP, the positioning and timing module is capable of independent operation, and can independently process data from sensors connected to its digital and analog interfaces. This module wakes up an application processor only when necessary, enabling more optimized power management capabilities, and achieves continuous information collection at fixed measurement positions and automatically stores results in the solid-state memory inside the detector. The positioning and timing module implements microsecond-level precision for synchronous acquisition in a wide-area system. The high-sensitivity active antenna utilizes satellite-based high-precision timing technology and supports embedded applications, reducing the probability of satellite timing loss. It should be noted that specific configurations are processed by the cloud platform to ensure normal operation.

The fixed measurement position refers to a fixed measurement position in the monitoring area.

In the present disclosure, the STM32 L4 series ultra-low-power microcontroller is used, pushing the performance limits in the current field of ultra-low power. It is based on the ARM® Cortex®-M4 core with a floating-point unit (FPU) and ART Accelerator™ technology of STMicroelectronics, delivering performance up to 100 DMIPS at an 80 MHz CPU frequency. The microcontroller can dynamically adjust the voltage according to different application requirements during runtime of the microprocessor to achieve dynamic balance of power consumption. This function is suitable for low-power peripherals in STOP mode (such as lower-power Universal Asynchronous Receiver-Transmitters (LP UARTs) and low-power (LP) timers), security and confidentiality features, numerous intelligent peripherals, and advanced low-power analog peripherals including operational amplifiers, comparators, liquid crystal displays (LCDs), 12-bit digital-to-analog converters (DACs), and 16-bit analog-to-digital converters (ADCs) (hardware oversampling).

In the fifth step, the 5G data transmission module collects data, where the 5G network module includes a baseband chip, an RF module, and a PCI-E interface, and is compatible with IoT cards from the three major carriers: China Mobile, China Telecom, and China Unicom. It supports various communication protocols like TCP, UDP, HTTP, WebSocket, and transmits the data to the cloud platform. With the dual communication assurance of the active antenna and the external 5G data transmission module, comprehensive data reliability is achieved in dynamic and complex environments.

Step 3: Output values of a time series.

The embedded data processing platform integrates the FFT, CFAR detection algorithm, frame differencing, background subtraction algorithm, and natural source frequency imaging algorithm, to obtain surface 2D deformation information of the landslide mass and information about a longitudinal force on a 3D stratigraphic landslide mass. The data processing platform also exports digital signals of 2D surface deformation data and 3D underground frequency data within the same time series, enabling data comparison between the 2D surface acceleration deformation and the 3D underground acceleration creep area.

Step 4: Perform comprehensive analysis.

The embedded data processing platform is integrated with an electromagnetic-seismic fusion algorithm. When the amplitude of the slip surface in frequency imaging shifts towards lower values, it indicates a looser slip surface and a higher landslide risk. When the deformation velocity of the landslide mass becomes lower, it predicts a looser landslide mass and a higher landslide risk. High-frequency electromagnetic wave data and low-frequency seismic wave data from the same time series are analyzed, to generate deformation curves, velocity curves, and acceleration curves for both data types. The maximum subsidence amount and subsidence velocity in different time intervals are analyzed. The deformation curves of the electromagnetic waves and seismic waves are fitted to pinpoint a 3D coordinate range of the landslide. Meanwhile, considering factors such as on-site vegetation, vehicles, lighting, and climate, other influencing factors are differentially filtered to scientifically report a landslide creep trajectory, thus obtaining information such as landslide position, velocity, and movement trajectory accurately.

The high-frequency electromagnetic wave data is the output of the high-frequency electromagnetic wave monitoring module. The low-frequency seismic wave data is the output of the low-frequency seismic wave monitoring module.

The maximum subsidence amount refers to a value at the lowest point within a certain time range in the deformation curve, which includes the subsidence curve.

The subsidence velocity refers to a cumulative subsidence value, which is obtained by subtracting a lowest subsidence value from a highest subsidence value within a certain time length, divided by the corresponding time length.

Step 5: Issue a threshold-based alert. The cloud platform receives and stores real-time information such as the landslide position, velocity, and movement trajectory. A yellow warning is triggered when the velocity exceeds 5 mm/h, and a red warning is triggered when the velocity exceeds 8 mm/h. This allows for timely on-site warnings.

The joint landslide monitoring system of the present disclosure further includes a power supply, which can be a 130WH rechargeable lithium battery pack, which can record continuously for more than 800 hours. It can be optionally equipped with an external high-capacity battery unit or external solar panels with a battery backup. During monitoring, the external batteries take precedence, with the internal batteries serving as a backup. The built-in power management unit automatically switches between the external and internal batteries to provide power to the entire device.

The joint landslide monitoring system of the present disclosure provides mountain landslide monitoring and early warning based on electromagnetic-seismic fusion. The present disclosure primarily relies on the high-frequency electromagnetic wave monitoring technology using slope radars, and also integrates the low-frequency seismic wave imaging technology of the detector. This combination allows for the complementary use of both monitoring methods, effectively enhancing the efficiency of monitoring and early warning.

### Embodiment 2

This embodiment provides a joint landslide monitoring method, including the following steps:

A high-frequency electromagnetic wave monitoring module continuously emits electromagnetic wave signals into a monitoring area through a transmitting antenna, and scans space of the monitoring area with emitted waves by changing a phase distribution on an aperture of the transmitting antenna; amplifies signals received by a receiving antenna and performs interference processing on the amplified signals to obtain target signals; and obtains surface deformation information of the monitoring area according to a phase difference of the target signals, where the surface deformation information includes a position of a landslide mass and landslide velocity information.

A low-frequency seismic wave monitoring module propagates seismic waves downward from a ground surface in the monitoring area, and receives reflected waves from a creeping medium that the seismic waves encounter, where the reflected waves continue to propagate downward after reaching the ground surface; obtains frequency-domain interference characteristics of internal creeping in the monitoring area according to the reflected waves received in multiple times; and determines, according to the frequency-domain interference characteristics, a longitudinal force on a 3D stratigraphic landslide mass shear surface in the monitoring area based on a natural source three-component earthquake frequency imaging technology.

A cloud platform collects the surface deformation information sent by the high-frequency electromagnetic wave monitoring module and the longitudinal force on the 3D stratigraphic landslide mass shear surface sent by the low-frequency seismic wave monitoring module; determines a maximum subsidence amount and a subsidence velocity of the monitoring area according to the surface deformation information and the longitudinal force on the 3D stratigraphic landslide mass shear surface collected within a same period of time; and issues alert information when the maximum subsidence amount exceeds a subsidence amount threshold or the subsidence velocity exceeds a subsidence velocity threshold.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A joint landslide monitoring system, comprising:
a high-frequency electromagnetic wave monitoring module configured to continuously emit electromagnetic wave signals into a monitoring area through a transmitting antenna, and scan space of the monitoring area with emitted waves by changing a phase distribution on an aperture of the transmitting antenna; amplify signals received by a receiving antenna and perform interference processing on the amplified signals to obtain target signals; and obtain surface deformation information of the monitoring area according to a phase difference of the target signals, wherein the surface deformation information comprises a position of a landslide mass and landslide velocity information;
a low-frequency seismic wave monitoring module configured to propagate seismic waves downward from a ground surface in the monitoring area and receive reflected waves from a creeping medium that the seismic waves encounter, wherein the reflected waves continue to propagate downward after reaching the ground surface; obtain frequency-domain interference characteristics of internal creeping in the monitoring area according to the reflected waves received in multiple times; and determine, according to the frequency-domain interference characteristics, a longitudinal force on a 3D stratigraphic landslide mass shear surface in the monitoring area; and
a cloud platform configured to collect the surface deformation information sent by the high-frequency electromagnetic wave monitoring module and the longitudinal force on the 3D stratigraphic landslide mass shear surface sent by the low-frequency seismic wave monitoring module; determine a maximum subsidence amount and a subsidence velocity of the monitoring area according to the surface deformation information and the longitudinal force on the 3D stratigraphic landslide mass shear surface collected within a same period of time; and issue alert information when the maximum subsidence amount exceeds a subsidence amount threshold or the subsidence velocity exceeds a subsidence velocity threshold.

2. The joint landslide monitoring system according to claim 1, wherein the high-frequency electromagnetic wave monitoring module comprises:
a synthesizer configured to generate frequency-modulated signals;
the transmitting antenna configured to continuously emit the frequency-modulated signals into the monitoring area, wherein the frequency-modulated signals are electromagnetic wave signals;
the receiving antenna configured to receive mixed-frequency signals, which are a mixture of the frequency-modulated signals and delayed frequency-modulated signals reflected back;
a filter connected to the receiving antenna and configured to filter out intermediate frequency signals within a preset frequency range;
a first analog-to-digital converter connected to the filter and configured to convert the intermediate frequency signals into digital signals, referred to as first digital signals;
a digital signal processor (DSP) connected to the first analog-to-digital converter and configured to perform a fast Fourier transform (FFT) on the digital signals; and
a constant false alarm rate (CFAR) detection module connected to the DSP and configured to perform CFAR detection on the digital signals after the FFT, to obtain high-frequency electromagnetic wave data.

3. The joint landslide monitoring system according to claim 1, wherein the low-frequency seismic wave monitoring module comprises:
a detector configured to propagate seismic waves downward from the ground surface in the monitoring area, collect mechanical signals representing linear vibrations of the ground surface in the monitoring area, and convert the mechanical signals into electrical signals;
a period extender connected to the detector and configured to extend a frequency bandwidth of the detector to obtain bandwidth-extended signals; and
a second analog-to-digital converter, which is a multi-channel analog-to-digital converter, connected to the period extender and configured to convert the bandwidth-extended signals into digital signals, referred to as second digital signals, according to requirements of each channel.

4. The joint landslide monitoring system according to claim 3, wherein the detector comprises a three-axis vibration sensor configured to detect mechanical signals of linear vibrations in three Cartesian axis directions.

5. The joint landslide monitoring system according to claim 1, wherein the subsidence velocity threshold is 5 mm/h.

6. The joint landslide monitoring system according to claim 1, further comprising a first 5G data transmission module and a second 5G data transmission module, wherein the high-frequency electromagnetic wave monitoring module and the cloud platform are connected through the first 5G data transmission module, and the low-frequency seismic wave monitoring module and the cloud platform are connected through the second 5G data transmission module.

7. A joint landslide monitoring method, comprising:
continuously emitting, by a high-frequency electromagnetic wave monitoring module, electromagnetic wave signals into a monitoring area through a transmitting antenna, and scanning space of the monitoring area with emitted waves by changing a phase distribution on an aperture of the transmitting antenna; amplifying signals received by a receiving antenna and performing interference processing on the amplified signals to obtain target signals; and obtaining surface deformation information of the monitoring area according to a phase difference of the target signals, wherein the surface deformation information comprises a position of a landslide mass and landslide velocity information;
propagating, by a low-frequency seismic wave monitoring module, seismic waves downward from a ground surface in the monitoring area, and receiving reflected waves from a creeping medium that the seismic waves encounter, wherein the reflected waves continue to propagate downward after reaching the ground surface; obtaining frequency-domain interference characteristics of internal creeping in the monitoring area according to the reflected waves received in multiple times; and determining, according to the frequency-domain interference characteristics, a longitudinal force on a 3D stratigraphic landslide mass shear surface in the monitoring area; and
collecting, by a cloud platform, the surface deformation information sent by the high-frequency electromagnetic wave monitoring module and the longitudinal force on the 3D stratigraphic landslide mass shear surface sent by the low-frequency seismic wave monitoring module; determining a maximum subsidence amount and a subsidence velocity of the monitoring area according to the surface deformation information and the longitudinal force on the 3D stratigraphic landslide mass shear surface collected within a same period of time; and issuing alert information when the maximum subsidence amount exceeds a subsidence amount threshold or the subsidence velocity exceeds a subsidence velocity threshold.
